(19) United States
(12) Patent Application Publication
(10) Pub. No.: US 2008/0124678 A1
(43) Pub. Date: May 29, 2008

(54) Dental prosthetic appliance

(75) Inventors: Sadami Tsutsumi, Kyoto (JP); Yoshio Okano, Shiga (JP); Kentarou Toyosu, Osaka (JP)

Correspondence Address: HAMRE, SCHUMANN, MUELLER & LARSON, P.C., P.O. BOX 2902, MINNEAPOLIS, MN, 55402-0902, US

(73) Assignee: The Nippon Synthetic Chemical Industry Co., Ltd., Osaka-shi (JP)

(21) Appl. No.: 11/894,986

(22) Filed: Aug. 22, 2007

(30) Foreign Application Priority Data
Aug. 23, 2006 (JP) 2006-226662

(51) Int. Cl. A61C 13/01; A61C 13/08; C08F 118/08

(52) U.S. Cl. 433/199.1; 433/202.1; 526/319

(57) ABSTRACT

A dental prosthetic appliance excellent in adhesion to the oral mucosa is provided. A saponified ethylene-vinyl ester copolymer is used as a material for the dental prosthetic appliance.

### BACKGROUND OF THE INVENTION

1. Field of the Invention

The present invention relates to a dental prosthetic appliance having, as a main component thereof, a plastic material. More specifically, the invention pertains to a dental prosthetic appliance having adequate strength and a high level of safety, and excellent in affinity and adhesion to the oral mucosa.

2. Background Art

The term “dental prosthetic appliance” as used herein means an appliance for complementing a lost tooth, a member constituting a portion thereof, or endodontic equipment each of which is applied in the oral cavity, such as full denture, partial denture or orthodontic appliance. Specific examples include denture, denture base, gingival cover, fitting member (clasp or rest) for fixing to human bodies, bridge, crown, upper structure of implant, inlay, anlay, connector or bar for each of parts, orthodontic wire, bracket, mouthpiece or nightguard for protecting teeth or mouth, and splint.

Various high-level conditions are necessary for materials used for such dental prosthetic appliances including safety, strength, aesthetic aspect, moldability or formability and the like. In order to satisfy these conditions, various investigations have been made on materials for dental prosthetic appliances.

For example, polyacrylic resins were conventionally been used as a material for a base of full denture or partial denture. They had however problems such as low durability and mechanical strength.

In recent years, a denture base obtained by melt molding or forming of a polycarbonate resin having a high mechanical strength has been used, A composite material of polycarbonate and liquid crystalline polyester has been proposed most recently as a material having a relatively low melt viscosity and therefore having excellent moldability or formability, and at the same time having high mechanical strength (refer to, for example, Japanese Patent Laid-Open No. 2002-173408). Polycarbonate is however made of bisphenol A having an endocrine disruption action so that there is a possibility of bisphenol A being generated even by the hydrolysis of polycarbonate. Thus, it is harmful to human bodies.

A denture base using a polyester resin as a substitute material free from the problem of endocrine disruption action has been proposed (refer to, for example, Japanese Patent Laid-Open No. 2005-060353). These materials however have insufficient affinity for the oral mucosa. Another problem is that continued use of them deteriorates the compatibility of the dentures to the oral mucosa owing to alveolar ridge absorption or like, to finally causes a pain at a site to which a biting force has been applied.

Recently, in full dentures and partial dentures each made of a plastic material alone, an aesthetic denture, which can be fixed well to the oral cavity without using a metal fitting member, is proposed. A special fixing structure to bring a denture base into contact with the dental crown of a natural tooth enables such an aesthetic denture (refer to, for example, Japanese Patent Laid-Open Nos. 2002-078721 and No. 2003-116884). The specifications of these documents however include neither description on the above-described problems nor specific disclosure of a plastic material which leads to the resolution of the problems. There is therefore a demand for the development of a material which can be applied to such a technology and can overcome the above-described problems.

For fitting members (such as clasp and rest) to fix a partial denture or orthodontic appliance, metal materials are used because owing to high strength and high elastic modulus, they have excellent fixing capacity and moreover, their fixing angle can be fine-tuned readily. Metal materials however have a problem that at the time of fitting or removal, they damage an adjacent natural teeth or oral mucosa and cause allergy to the metals. As a solution of this problem, a dental prosthetic appliance using, as a fitting member, a plastic material such as acetal resin is proposed (refer to, for example, Japanese Patent Laid-Open No. 2004-081857). This dental prosthetic appliance uses a fibrous or particulate filler in combination in order to adjust its flexural modulus to from 10 to 80 GPa and maximum elongation to from 0.8 to 4% and thereby attain retention properties comparable to those of metal materials. Such a modulus of elasticity is however still too high and a reduction of it is required for decreasing the burden applied to adjacent teeth at the time of fitting or removal. A prosthetic appliance having a plastic fitting member made of a material with higher flexibility and a flexural modulus less than 10 GPa is under investigation, but materials capable of fully satisfying overall characteristic have not yet been obtained.

### SUMMARY OF THE INVENTION

An object of the present invention is to provide a dental prosthetic appliance excellent in affinity and adhesion to the oral mucosa.

With the foregoing in view, the present inventors have carried out an extensive investigation. As a result, it has been found that the object of the present invention is accomplished by the use of a saponified ethylene-vinyl ester copolymer (which will hereinafter be abbreviated as “EVOH”) as a material of a dental prosthetic appliance, leading to the completion of the present invention.

In one aspect of the present invention, there is thus provided the following dental prosthetic appliances.

1. A dental prosthetic appliance comprising a plastic material, wherein the plastic material is a saponified ethylene-vinyl-ester copolymer.

2. The dental prosthetic appliance according to the item 1, wherein the saponified ethylene-vinyl ester copolymer is a saponified ethylene-vinyl acetate copolymer.

3. The dental prosthetic appliance according to the item 1 or 2, wherein the saponified ethylene-vinyl ester copolymer has an ethylene structural unit content of 1 to 70 mole %.

4. The dental prosthetic appliance according to the item 1 or 2, wherein the saponified ethylene-vinyl ester copolymer has an ethylene structural unit content of 10 to 60 mole %.

5. The dental prosthetic appliance according to the item 1 or 2, wherein the saponified ethylene-vinyl ester copolymer has an ethylene structural unit content of 20 to 55 mole %.

6. The dental prosthetic appliance according to the item 1 or 2, wherein the saponified ethylene-vinyl ester copolymer has an ethylene structural unit content of 25 to 50 mole %.

7. The dental prosthetic appliance according to any one of the items 1 to 6, wherein the saponified ethylene-vinyl ester copolymer has an average saponification degree of 80 to 100 mole %.

8. The dental prosthetic appliance according to any one of the items 1 to 6, wherein the saponified ethylene-vinyl ester copolymer has an average saponification degree of 90 to 100 mole %.

9. The dental prosthetic appliance according to any one of the items 1 to 6, wherein the saponified ethylene-vinyl ester copolymer has an average saponification degree of 95 to 100 mole %.

10. The dental prosthetic appliance according to any one of the items 1 to 6, wherein the saponified ethylene-vinyl ester copolymer has an average saponification degree of 99 to 100 mole %.

11. The dental prosthetic appliance according to any one of the items 1 to 10, wherein the saponified ethylene-vinyl ester copolymer has a remaining amount of sodium acetate of 1,000 ppm or less, in terms of sodium.

12. The dental prosthetic appliance according to any one of the items 1 to 10, wherein the saponified ethylene-vinyl ester copolymer has a remaining amount of sodium acetate of 500 ppm or less, in terms of sodium.

13. The dental prosthetic appliance according to any one of the items 1 to 10, wherein the saponified ethylene-vinyl ester copolymer has a remaining amount of sodium acetate of 300 ppm or less, in terms of sodium.

14. The dental prosthetic appliance according to any one of the items 1 to 13, wherein the saponified ethylene-vinyl ester copolymer has a melt flow rate at 210° C. under a load of 2,160 g of 0.5 to 100 g/10 minutes.

15. The dental prosthetic appliance according to any one of the items 1 to 13, wherein the saponified ethylene-vinyl ester copolymer has a melt flow rate at 210° C. under a load of 2,160 q of 1 to 50 g/10 minutes.

16. The dental prosthetic appliance according to any one of the items 1 to 13, wherein the saponified ethylene-vinyl ester copolymer has a melt flow rate at 210° C. under a load of 2,160 g of 3 to 40 g/10 minutes.

17. The dental prosthetic appliance according to any one of the items 1 to 16, wherein the saponified ethylene-vinyl ester copolymer has a contact angle with water of 5° to 85°.

18. The dental prosthetic appliance according to any one of the items 1 to 16, wherein the saponified ethylene-vinyl ester copolymer has a contact angle with water of 30° to 80°.

19. The dental prosthetic appliance according to any one of the items 1 to 18, wherein the saponified ethylene-vinyl ester copolymer has a flexural elasticity from 1 to 9.9 Gpa.

20. The dental prosthetic appliance according to any one of the items 1 to 19, which contains a filler in an amount of from 0.5 to 45 parts by weight.

21. The dental prosthetic appliance according to any one of the items 1 to 20, wherein the saponified ethylene-vinyl ester copolymer further contains a 1,2-diol structural unit represented by the following formula (1):

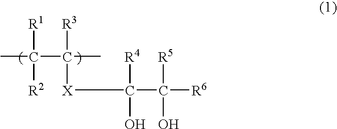

wherein R¹, R² and R³ each independently represents a hydrogen atom or an organic group, X represents a single bond or linking chain, and R⁴, R⁵ and R⁶ each independently represents a hydrogen atom or an organic group.

22. The dental prosthetic appliance according to any one of the items 1 to 20, wherein the saponified ethylene-vinyl ester copolymer further contains a 1,2-diol structural unit represented by the following formula (1) from 0.1 to 20 mole %:

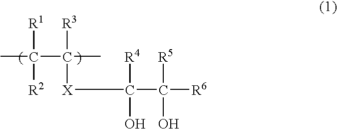

wherein R¹, R² and R³ each independently represents a hydrogen atom or an organic group, X represents a single bond or linking chain, and R⁴, R⁵ and R⁶ each independently represents a hydrogen atom or an organic group.

23. The dental prosthetic appliance according to the item 1, wherein the saponified ethylene-vinyl ester copolymer is a saponified ethylene-vinyl acetate copolymer, which has an ethylene structural unit content of 10 to 60 mole %, has an average saponification degree of 80 to 100 mole %, has a melt flow rate at 210° C. under a load of 2,160 g of 0.5 to 100 g/10 minutes, and has a contact angle with water of 5° to 85°, and has a flexural modulus of 1 GPa to 9.9 GPa.

24. The dental prosthetic appliance according to the item 1, wherein the saponified ethylene-vinyl ester copolymer is a saponified ethylene-vinyl acetate copolymer, which has an ethylene structural unit content of 10 to 60 mole %, has an average saponification degree of 80 to 100 mole %, has a melt flow rate at 210° C. under a load of 2,160 g of 0.5 to 100 g/10 minutes, has a contact angle with water of 5° to 85°, has a remaining amount of sodium acetate of 1,000 ppm or less, in terms of sodium, and has a flexural modulus of 1 GPa to 9.9 GPa.

An EVOH is a resin having good hydrophilicity, exhibiting good adhesion to the oral mucosa because it swells with the saliva in the oral cavity, having adequate hardness, excellent in safety because it does not emit any component toxic to human bodies even by heating or hydrolysis, and excellent in moldability or formability because it is a thermoplastic resin. By making use of such characteristics, advantages specific to the invention can be realized.

In another aspect of the present invention, there is also provided a denture base comprising an EVOH. Such a denture base has good hydrophilicity and swells with the saliva in the oral cavity so that it exhibits good adhesion to the oral mucosa. As a result, it hardly causes discomfort or pain.

In a further aspect of the present invention, there is also provided a denture fitting member comprising EVOH. Such a fitting member has good hydrophilicity and has adequate hardness so that it has an adequate fixing capacity, while not damaging the adjacent teeth or mouth. The denture fitting member preferably has a flexural modulus of 2 GPa to 9.9 GPa.

The dental prosthetic appliance according to the invention is especially useful because it has excellent adhesion to the oral mucosa, has adequate strength, has a high level of safety and can be manufactured easily.

### BRIEF DESCRIPTION OF THE DRAWING

FIG. 1 is an embodiment of a partial denture base according to the invention.

### DESCRIPTION OF REFERENCE NUMERALS AND SIGNS

1 Denture base
2 Fitting member (clasp)
3, 3′ Denture

### DETAILED DESCRIPTION OF THE INVENTION

The constitution requirements which will be described herein are given as one example (typical example) of the embodiments of the present invention, but the invention is not limited to or by them.

The present invention will hereinafter be described specifically.

The EVOH to be used in the invention is a copolymer comprising an ethylene structural unit and a vinyl alcohol structural unit, and the copolymer may be obtained by the saponification of a copolymer made of ethylene and vinyl ester monomer.

The ethylene structural unit content in the EVOH to be used in the invention is typically preferably from 1 to 70 mole %, more preferably from 10 to 60 mole %, especially preferably from 20 to 55 mole %, most preferably from 25 to 50 mole %. Too small ethylene structural unit contents tend to increase the water absorption of the resulting EVOH and therefore reduce the mechanical strength such as flexural modulus in the oral cavity during use. Too large ethylene structural unit contents, on the other hand, tend to lead insufficient mechanical strength such as flexural modulus.

The vinyl alcohol structural unit content in the EVOH to be used in the invention is typically preferably from 24 to 99 mole %, more preferably from 36 to 90 mole %, especially preferably from 43 to 80 mole %, most preferably from 50 to 75 mole %. Too small vinyl alcohol structural unit contents tend to lead insufficient mechanical strength such as flexural modulus. Too large vinyl, alcohol structural unit contents, on the other hand, tend to increase the water absorption of the resulting EVOH and therefore reduce the mechanical strength such as flexural modulus in the oral cavity during use.

An average saponification degree in the EVOH is typically preferably 80 to 100 mole %, more preferably 90 to 100 mole %, especially preferably 95 to 100 mole %, most preferably 99 to 100 mole %. Too low average saponification degrees tend to increase the water absorption of the resulting EVOH and therefore reduce the mechanical strength such as flexural modulus in the oral cavity during use. A remaining amount, in the EVOH, of sodium acetate which has been by-produced during such saponification is typically preferably 1,000 ppm or less, more preferably 500 ppm or less, especially preferably 300 ppm or less, each in terms of sodium.

The vinyl ester structural unit, as a remaining functional group by the saponification, the vinyl ester structural unit content in the EVOR to be used in the invention is typically preferably from 0 to 75 mole %, more preferably from 0 to 54 mole %, especially preferably from 0 to 37 mole %, most preferably from 0 to 25 mole %.

The melt flow rate (MFR) (at 210° C. under a load of 2,160 g) of the EVOH is preferably from 0.5 to 100 g/10 minutes, more preferably from 1 to 50 g/10 minutes, especially preferably from 3 to 40 g/10 minutes, most preferably from 5 to 30 g/10 minutes. Too low melt flow rates tend to cause difficulties in the filling of the resulting EVOH resin at the time of melt molding such as infection molding or compression molding. Too high melt flow rates, on the other hand, make the filling of the resulting EVOH resin unstable.

The wettability of the EVOH is, in terms of a contact angle with water as measured by the sessile water drop method by using a contact angle meter (“FAMAS” product of Kyowa Interface Science, at 23° C. and 50% RH), typically preferably from 5° to 85°, more preferably from 30° to 80°, especially preferably from 45° to 80°.

The flexural elasticity of the EVOH is typically from 1 to 9.9 GPa, more preferably from 2 to 9.8 GPa, especially preferably from 3 to 9.7 GPa as measured in accordance with ISO 178 based on ISO 1466.

An ethylene-vinyl ester copolymer of the EVOH prior to saponification can be prepared by any known polymerization process, for example, solution polymerization, suspension polymerization, or emulsion polymerization. It is typically prepared by solution polymerization using methanol. Although saponification can be performed by a known process using an acid catalyst or alkali catalyst, it can be typically performed as alkali saponification using sodium hydroxide.

Examples of the vinyl ester monomer include vinyl esters of an aliphatic hydrocarbon such as vinyl formate, vinyl acetate, vinyl propionate, vinyl valerate, vinyl butyrate, vinyl isobutyrate, vinyl pivalate, vinyl caprate, vinyl laurate and vinyl stearate, vinyl esters of an aromatic hydrocarbon such as vinyl benzoate, and vinyl versatate. From the economical viewpoint, the number of carbon atoms of the vinyl ester monomer is typically preferably from 3 to 15, more preferably from 3 to 10, especially preferably from 4 to 6. That having 4 carbon atoms, that is, vinyl acetate is most preferred. These vinyl ester monomers may be used singly or plural ones may be used simultaneously.

The above-described EVOH may be copolymerized with a copolymerizable unsaturated monomer within a range not departing from the object of the present invention. Examples of such a monomer include unsaturated hydrocarbons such as propylene, 1-butene and isobutene; unsaturated carboxylic acids such as acrylic acid, methacrylic acid, crotonic acid, phthalic acid (anhydride), maleic acid (anhydride) and itaconic acid (anhydride) or salts, mono-alkyl esters or di-alkyl esters thereof; acrylamide derivatives, for example, acrylamide, mono- or di-alkyl-substituted acrylamides such as N-methylacrylamide and N,N-dimethylacrylamide, acrylamidoalkanesulfonic acids and salts thereof, acrylamidoalkylamine or acid salts or quaternary salts thereof; methacrylamide derivatives, for example, methacrylamide, mono- or di-alkyl-substituted acrylamides such as N-methylmethacrylamide and N,N-dimethylmethacrylamide, 2-methacrylamidoalkanesulfonic acids and salts thereof, methacrylamidoalkylamines or acid salts thereof or quaternary salts thereof; cyclic vinylamides such as N-vinylpyrrolidone; N-vinylamides such as N-vinylformamide and N-vinylacetamide; vinyl cyanides such as acrylonitrile and methacrylonitrile; vinyl ethers such as alkyl vinyl ethers, hydroxyalkyl vinyl ethers and alkoxyalkyl vinyl ethers; vinyl halides such as vinyl chloride, vinylidene chloride, vinyl fluoride, vinylidene fluoride and vinyl bromide; allyl compounds such as allyl acetate, allyl chloride, allyl alcohol and dimethylallyl alcohol; cationic-group-containing unsaturated compounds such as allyl trimethylammonium chloride and methallyl trimethylammonium chloride; silicon-containing unsaturated compounds such as vinyltrimethoxysilane and vinyldimethoxylauryloxysilane, and acetoacetyl-containing unsaturated compounds. These monomers may be used either singly or in combination of two or more. From the standpoints of production efficiency and stability of the product, these monomers have typically preferably from 1 to 30 carbon atoms, more preferably from 1 to 15 carbon atoms, especially preferably from 1 to 10 carbon atoms.

The EVOH may be post-modified by a known process such as hydroxyalkyl etherification with an epoxy compound, urethanation, acetalization or cyanoethylation within a range that does not impair the properties of the resin.

Moreover, in the invention, the EVOH may contain, in the side chain thereof, a 1,2-diol structural unit represented by the following formula (1). The content of such a structural unit represented by the formula (1) in the EVOH is typically from 0.1 to 20 mole %, preferably from 0.1 to 15 mole %, more preferably from 0.1 to 10 mole %:

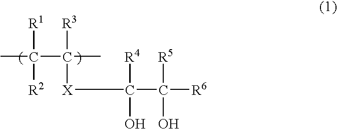

[in the formula (1), R¹, R² and R³ each independently represents a hydrogen atom or an organic group, X represents a single bond or linking chain, and R⁴, R⁵ and R⁶, each independently represents a hydrogen atom or an organic group].

No particular limitation is imposed on the organic group in the formula (1) and the examples include saturated hydrocarbon groups such as methyl, ethyl, n-propyl, isopropyl, n-butyl, isobutyl and tert-butyl, and aromatic hydrocarbon groups such as phenyl and benzyl. They may have a substituent such as halogen atom, hydroxyl group, acyloxy group, alkoxycarbonyl group, carboxyl group or sulfonic acid group.

As each of R¹ to R³, alkyl groups having typically preferably from 1 to 30, especially preferably from 1 to 15, still more preferably from 1 to 4 carbon atoms and a hydrogen atom are preferred. As R⁴ to R⁶, alkyl groups having typically preferably from 1 to 30, especially preferably from 1 to 15, still more preferably from 1 to 4 carbon atoms and a hydrogen atom are preferred, with hydrogen atom being most preferred. It is especially preferred that R¹ to R⁶ each represents a hydrogen atom and X represents a single bond.

In the invention, use of such an EVOH having a structural unit represented by the formula (1) enables to heighten hydrophilicity and therefore improves adhesion to the inside of the oral cavity.

In addition, X in the structural unit represented by the formula (1) is typically a single bond, but may be a linking chain if the advantage of the invention is not impaired. Although no particular limitation is imposed on the linking chain, examples of it include, in addition to hydrocarbons such as alkylene, alkenylene, alkynylene, phenylene and naphthylene (these hydrocarbons may be substituted with a halogen atom such as fluorine, chlorine or bromine), ether-bond-site-containing structures such as —O—, —(CH₂O)ₘ—, —(OCH₂)ₘ—, and —(CH₂O)ₘCH₂—, carbonyl-containing structures such as —CO—, —COCO—, —CO(CH₂)ₘCO— and —CO(C₆H₄)CO—, hetero-atom-containing structures, for example, sulfur-containing structures such as —S—, —CS—, —SO— and —SO₂—, nitrogen-containing structures such as —NR—, —CONR—, —NRCO—, —CSNR—, —NRCS— and —NRNR—, and phosphorus-containing structures such as —HPO₄—, and metal-atom-containing structures, for example, silicon-containing structures such as —Si(OR)₂—, —OSi(OR)₂—, and —OSi(OR)₂O—, titanium-containing structures such as —Ti(OR)₂—, —OTi(OR)₂— and —OTi(OR)₂O— and aluminum-containing structures such as —Al(OR)—, —OAl(OR)— and —OAl(OR)O— (Rs each independently represents a substituent, with a hydrogen atom or alkyl group being preferred, and m stands for a counting number, typically from 1 to 30, preferably from 1 to 15, more preferably from 1 to 10). Of these, —CH₂OCH₂— and C₁₋₁₀ alkylene groups are preferred from the standpoints of stability during preparation and use, with C₁₋₆ alkylene groups, especially C₁ alkylene group being preferred.

Although no particular limitation is imposed on the preparation process of the EVOH having a structural unit of the formula (1), preferred is a process of saponifying a copolymer of, for example, a vinyl ester monomer, ethylene and a compound represented by the following formula (2):

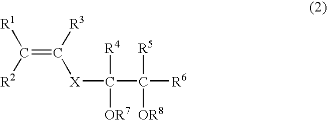

[in the formula (2), R¹, R² and R³ each independently represents a hydrogen atom or an organic group,

X represents a single bond or a linking chain,

R⁴, R⁵ and R⁶ each independently represents a hydrogen atom or an organic group, and

R⁷ and R⁸ each independently represents a hydrogen atom or an acyl group].

The compound of the formula (2) having an acyl group as each of R⁷ and R⁸ can be converted into the structural unit represented by the formula (1) by hydrolysis.

The compound represented by the formula (2) is typically 3,4-diacetoxybutene, that is, a compound of the formula (2) having a hydrogen atom as each of R¹ to R⁶, a single bond as X, and an acetyl group as each of R⁷ and R⁸.

Another preparation process is, for example, saponification and decarboxylation of a copolymerized product obtained using vinyl ethylene carbonate as a comonomer of ethylene and a vinyl ester compound; saponification and deketalization using, as a comonomer, a compound represented by the following formula (3):

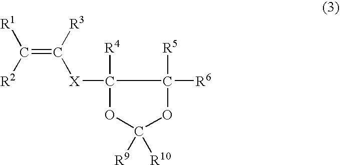

[in the formula (3), R¹, R² and R³ each independently represents a hydrogen atom or an organic group,

X represents a single bond or a linking chain,

R⁴, R⁵ and R⁶ each independently represents a hydrogen atom or an organic group, and

R⁹ and R¹⁰ each independently represents a hydrogen atom or an organic group], or saponification of the product obtained by using glycerin monoallyl ether as a comonomer.

The EVOH to be used in the invention may contain the following structural unit (4):

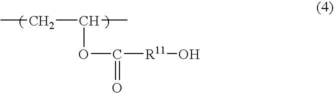

[wherein, R¹¹ represents a substituted or unsubstituted C₁₋₃₀ hydrocarbon chain]. The content of the above structural formula (4) is typically from 0.1 to S0 mole %, more preferably from 0.5 to 30 mole %, still more preferably from 0.8 to 20 mole %.

In the formula (4), R¹¹ represents a substituted or unsubstituted C₁₋₃₀ hydrocarbon chain, preferably a C₃₋₁₅ hydrocarbon chain, especially preferably a C₄₋₁₀ hydrocarbon chain. Specific examples thereof include alkylene groups such as methylene chain and ethylene chain. Such an alkylene group may have a halogen atom, hydroxyl group, acyloxy group, alkoxycarbonyl group, carboxyl group, ketone group, sulfonic acid group or the like within a range that does not impair the properties of the resulting resin.

Such an EVOH having a structural unit represented by the formula (4) can be prepared, for example, by ring-opening grafting of a lactone compound to EVOH. As such a lactone compound, those having from 3 to 15 carbon atoms are preferred, with ε-caprolactone being especially preferred. Since the EVOH having a structural unit of the formula (4) in which R¹¹ represents a hydrocarbon chain with 4 or greater carbon atoms has a Tg not greater than room temperature, it is preferably employed when the resulting resin must have flexibility in the oral cavity.

In the invention, two or more EVOHs different in ethylene content, average saponification degree, average polymerization degree, MFR, kind of a modifying group in the side chain, or content of the modifying group may be mixed and/or they may be used in combination and laminated one after another.

The content of the EVOH in the dental prosthetic appliance is typically from 1 to 100% by weight, more preferably from 10 to 100% by weight, still more preferably from 30 to 100% by weight. Too small content of the EVOH tends to lead to an insufficient effect of the invention.

Moreover, in the dental prosthetic appliance of the invention, within a range that does not impair the hydrophilicity of the EVOH, the EVOH may be mixed with a resin such as polyolefin, polyester, polyacrylic, polyacrylonitrile, polyamide, polyvinyl halide, polyvinyl alcohol or polyurethane resin, or a rubber such as silicon- or fluorine-containing rubber and/or the EVOH and such a resin or rubber used in combination may be stacked one after another. Two or more resins and rubbers different from each other may be used in combination.

In the dental prosthetic appliance of the invention, additives used for typical dental resin materials may be used in combination within a range that does not impair the characteristics of the EVOH. Examples of such additives include pigments, colorants, dyes, antioxidants, ultraviolet absorbers, antifouling agents such as fluorine compounds, surfactants, perfumes, deodorants and antibacterial agents. It is also possible to use known lubricants including saturated aliphatic amides such as stearic acid amide, unsaturated fatty acid amides such as oleic acid amide, bis-fatty acid amides such as ethylene bisstearic acid amide, and low-molecular-weight polyolefins, mold release agents, known plasticizers such as polyols, e.g., ethylene glycol, glycerin and hexanediol, particularly aliphatic polyols, and known heat stabilizers such as acids, e.g., acetic acid and phosphoric acid, metal salts thereof with an alkali metal or alkaline earth metal, and boron compounds such as boric acid and metal salts thereof.

In the dental prosthetic appliance of the invention, the EVOH may be mixed with a filler in order to have improved strength or rigidity and reduced elongation ratio. Any known fillers are usable regardless of whether they are organic or inorganic, or fibrous or particulate. Examples of fibrous fillers include organic fibers such as aramid fibers, vinylon fibers, silk fibers, aromatic polyamides and aromatic polyimides, and inorganic fibers such as glass fibers, carbon fibers, alumina fibers and gypsum fibers.

Such fibrous fillers have typically a diameter of from about 0.01 to 500 μm and a length of from 0.01 to 1000 μm. These fibrous fillers are usable in the form of rovings into which from tens to hundreds of thousands of single fibers have been gathered and bundled, short fibers or strands available from shortened single fibers, twisted yarns, woven fabrics, knit fabrics, commingled fabrics such as mats, clothes, ribbons and straws.

For a denture base, use of fibrous fillers in the form of rovings which are yarns obtained by assembling and bundling long fibers, woven fabrics or knit fabrics tends to bring about high reinforcing effects. For a fitting member, fibrous fillers in the form of short fibers, ribbons or straws are typically used from the standpoint of working efficiency.

In addition, particulate fillers are usable. The examples thereof include natural minerals such as wollastonite, sepiolite, xonotlite, dawsonite, mica, sericite and talc, synthetic minerals such as synthetic mica, carbon fillers such as graphite and carbon black, silicon fillers such as silica, glass beads, glass flakes, quartz powder, silicon carbide and silicon nitride, and inorganic fillers such as silicates, e.g., calcium silicate and zirconium silicate, carbonates, e.g., calcium carbonate and barium carbonate, berates, e.g., aluminum borate, metal oxides, e.g., potassium titanate, alumina, titanium oxide, zinc oxide, zirconium oxide and magnesium oxide, metal hydroxides, e.g., magnesium hydroxide, and sulfates such as barium sulfate. These fillers are usable in any form without limitation, for example, fractured, spherical or amorphous form. In addition, no particular limitation is imposed on the average particle size and their average particle size typically ranges from 0.001 to 1000 μm as measured by the laser diffraction scattering method.

These fillers are preferably surface treated with a known surface treatment agent such as silane coupling agent or titanate coupling agent in order to improve their adhesion with the EVOH. It is possible to use these fillers which are different in kind or shape respectively or use them in combination of two or more.

No particular limitation is imposed on the mixing method of the resin and additive with the EVOH and a desired mixing method is employed. Examples include dry blending, solution mixing and melt kneading. The mixing order of them is not also particularly limited and they can be mixed at any timing.

The amount of the above-described filler may be determined as needed, depending on the properties necessary for the using purpose. It is typically from 0.1 to 45 parts by weight based on 100 parts by weight of the EVOH.

The EVOH or EVOH composition thus obtained is used as a raw material for the dental prosthetic appliance of the invention.

The properties of the EVOH or EVOH composition to be used for the dental prosthetic appliance of the invention differ, depending on parts for which it is used so that they are adjusted as needed by using proper additives. In particular, a detailed description will next be made on parts to be brought into direct contact with the oral mucosa widely such as denture base, gingival cover and mouthpiece, and fixing parts such as fitting member, connector, wire and bracket.

In the dental prosthetic appliance of the invention, parts to be brought into direct contact with the oral mucosa widely such as denture base, gingival cover and mouthpiece are required particularly to show strong adhesion to the oral mucosa. Use of the EVOH, a material excellent in hydrophilicity, in the invention enables adequate expansion of the resulting appliance with the saliva in the oral cavity during use, whereby comfortable adhesion can be attained and in turn, the pain which will be caused by the continued use of it can be alleviated. The strength, flexural elasticity, and hydrophilicity (wettability) of the EVOH used for such parts can be adjusted as needed by the use of a proper additive.

When the EVOH is used for parts to be brought into direct contact with the oral mucosa widely such as denture base, gingival cover and mouthpiece, the filler is added in an amount of typically from 0.5 to 45 parts by weight, more preferably from 5 to 35 parts by weight, especially preferably from 10 to 25 parts by weight based on 100 parts by weight of the EVOH. In particular, mechanical reinforcing effects tend to increase by the use of a roving, that is, a yarn in which from tens to hundreds of thousands of long fibers each having a diameter of from 8 to 30 μm have been assembled.

The flexural elasticity of a mixture of the EVOH with the filler and additive is typically from 1 to 9.9 GPa, more preferably from 2 to 9.8 GPa, especially preferably from 3 to 9.7 Gpa, most preferably 4 to 9.7 Gpa as measured in accordance with ISO 178 based on ISO 1466.

The dental prosthetic appliance of the invention is produced in a known manner, for example, by the following manner.

1. Model the oral cavity of a patient, for example, by causing him (or her) to bring the teeth into occlusion while inserting a gum-like substance between upper and lower teeth, and casting plaster into a recess formed in the gum-like substance to prepare a plaster mold (impression) which has reproduced the shape of the oral cavity of the patient.

2. Remove the unnecessary portion from the impression to prepare a plaster cast which can be subjected to subsequent technical procedures.

3. Fix the plaster cast onto an articulator and artificial teeth are arranged based on the bite obtained from the patient (duplicate).

4. Carve a wax to fabricate a wax denture (wax-up, spruing).

5. Carry out investment soldering of the wax denture with plaster in a flask.

6. Pour out the wax thus invested with hot water or incinerate it in an electric furnace or the like to prepare a mold.

7. Heat and fluidize a resin for denture base in advance, cast the resulting resin in the mold and then solidify it by cooling.

8. Take out the solidified dental prosthetic appliance from the mold and subject it to mechanical processing and polishing.

9. Fine-tune the prosthetic appliance to the oral cavity of the patient and then, attach it.

As the melt molding method in the above procedure 7, a known method is employed. Examples of it include injection molding in which a resin which has been fluidized by heating is injected into a mold and then, in the mold, the resulting resin is cooled into a product; compression molding in which a material is charged in a mold of a general-purpose compression molder adjusted to an adequate temperature, and after closure of the mold, a pressure is applied thereto; transfer molding in which a material is charged in a portion of a mold called “pot” of a general-purpose compression molder adjusted to an adequate temperature and as soon as the mold is closed by applying a pressure thereto, the material runs from the pot into the mold through an inlet; vacuum molding and extrusion.

In a fabrication process of a full denture or partial denture having a special fixed structure in which the denture base is brought into contact with the coronal portion of a natural tooth, it can also be fabricated by a process, as shown in Japanese Patent No. 3403183, of integrating a fitting member portion with the denture base by embedding the former in the latter or adhering them together; or by a process, as shown in Japanese Patent No. 3732474, of softening a single veneer sheet by heating and causing the sheet to adhere to a mold by compressed wind or vacuum suction.

The molding or forming temperature is usually selected from a range of from 100 to 300° C. Compared with the temperature employed for conventionally employed polycarbonate resins or polysulfone resins, it can be set at lower temperature, which facilitates molding or forming using a general-purpose molding or forming machine.

Any shape can be adopted for parts which are brought into direct contact with the oral cavity widely such as denture base, gingival cover and mouthpiece, because they are formed or molded based on the model of the oral cavity of a patient. If the part is a full denture, it has typically a size of about 10 cm×10 cm×5 cm, while if the part is a partial denture; it has typically a size of about 5 cm×5 cm×5 cm. The base portion has a thickness of about from 0.1 to 6 mm. For fixing the prosthetic appliance to the oral cavity, a ultrasmall magnet or magnetic attachment may be disposed, or a metal such as palladium, titanium or gold, an alloy material therewith or another resin may be used partially in combination or may be stacked. It is also preferred to give irregularities to the surface of the appliance in order to prevent sticking of viscous foods thereto. No particular limitation is imposed on the material of a fitting member, connector or bar to be disposed and a fitting member made of a metal such as palladium alloy is usable. Alternatively, a plastic material such as polycarbonate or polyacetal resin, or an EVOH composition which will be described later may also be employed for it.

In the dental prosthetic appliance of the invention, fixing parts to human bodies such as fitting member connector, wire and bracket are required to have strength particularly. The strength, flexural elasticity, and hydrophilicity (wettability) of the EVOH to be used for such parts are adjusted as needed by the addition of a proper additive.

When the EVOH is used for the fixing parts to human bodies such as such as fitting member connector, wire and bracket, the amount of the filler added to the EVOH is not limited, though depending on the site to which it is fixed. The amount of the filler is typically from 0.5 to 45 parts by weight, more preferably from 5 to 35 parts by weight, especially preferably from 10 to 25 parts by weight based on 100 parts by weight of EVOH. In particular, mechanical reinforcing effects tend to increase by using the filler in the form of a roving, that is, a yarn into which from tens to hundreds of thousands of long fibers each having a diameter of from 8 to 30 μm have been gathered and bundled.

The flexural elasticity of a mixture of the EVOH with the filler and additive differs, depending on the site to which it is fixed, but is typically from 2.0 to 9.9 GPa, more preferably from 3.0 to 9.8 GPa, especially preferably from 4.0 to 9.7 GPa as measured based on ISO 178 in accordance with ISO 14663.

The fixing parts to human bodies such as fitting member, connector, wire and bracket according to the invention are produced typically by melt molding or forming. As the melt molding or forming, a known one is employed. Examples include the above-described injection molding, compression molding, transfer molding, vacuum molding and extrusion. The molding or forming method suited for the preparation of a desired shape of the part is selected as needed. Although any method is usable for the fabrication of a fitting member, it is fabricated, for example, by forming or molding simultaneously with a denture base, or by fine tuning, in the oral cavity of a patient, the fixing state of a metal fitting member possessed by a denture and then modeling the metal fitting member.

Such a fitting member can also be applied to a fabrication process, as disclosed in Japanese Patent No. 3403183, of a partial denture to be fixed to a denture base by embedding a fitting member portion therein or bonding it thereto to integrate them.

The fixing parts to human bodies such as fitting member, connector, wire and bracket have any shape, depending on a site to be fixed. A fitting member has a function of fixing a partial denture to a vicinal tooth. It has, for example, a shape, a portion of which is fixed to a partial denture and is brought into contact with an outer side surface of the dental crown of the vicinal tooth. The fitting member or wire has any shape, for example, a column or tapered column having a diameter of from about 0.1 to 5 mm, an elliptic column or tapered elliptic column having a minor axis of from about 0.1 to 3 mm and a major axis of from about 0.2 to 10 mm, or a ribbon or plate having a thickness of from about 0.1 to 3 mm and a width of from about 0.2 to 10 mm. A connector or bar has a function of fixing two or more partial denture bases and has any shape, for example, a ribbon or plate having a thickness of from about 0.1 to 3 mm and a width of from about 0.2 to 10 mm. A bracket has a function of conveying to teeth a tooth-moving power generated by a wire or rubber during orthodontic and it has any structure for fixing the wire. A metal or alloy material may be used in combination with these parts partially or may be stacked thereover.

The molding or forming temperature is often selected from a range of from 100 to 300° C., which is lower compared with the temperature employed for conventionally employed polycarbonate resins or polysulfone resins. This facilitates molding or forming using a general purpose apparatus.

To the dental prosthetic appliance of the invention, a known antifouling agent such as fluorine compound or antioxidant may be applied after molding or forming. It is also preferred to make the surface of the prosthetic appliance uneven in order to prevent sticking of viscous food products to the surface thereof.

The dental prosthetic appliance of the invention has excellent hydrophilicity so that it expands with the saliva when it is attached to the oral cavity and therefore, has improved adhesion with the oral mucosa, which prevents pain of the oral mucosa and in addition, has improved lubrication, making it possible to relieve the burden to adjacent natural teeth at the time of fitting or removal. Moreover, it has adequate strength, and does not generate harmful substances such as bisphenol A and dioxin at the time of heating or hydrolysis so that it is excellent in the safety to human bodies. Further, it is made of a thermoplastic resin having a relatively low molding or forming temperature so that it can be molded or formed easily.

### EXAMPLES

The present invention will hereinafter be described in detail by Examples.

All designations of “part” or “parts” and “%” mean part or parts by weight and wt. % unless otherwise specifically indicated.

### Example 1

After a diagnostic model was mounted in an articulator and surveying was performed using a surveyor, a duplicate model was formed from anhydrite. Using four ready made pattern waxes each having a width of 2 mm, length of 30 mm and thickness of 1.8 mm, wax-up of a locking portion was carried out in the duplicate model. After arrangement of artificial teeth made of an acrylic resin, a gingival was formed using 20 parts of a wax, followed by spruing and investment with a gypsum investment material.

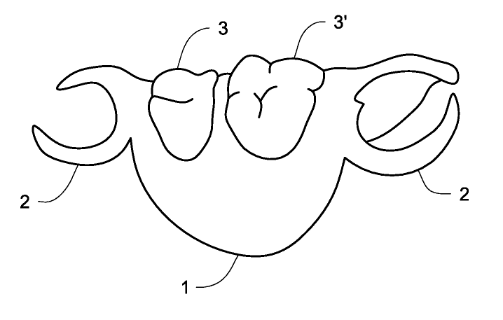

After dewaxing, 17 parts of a saponified ethylene-vinyl acetate copolymer (having an ethylene content of 29 mole %, an average saponification degree of 99.6 mole %; MFR of 8.2 g/10 min (as measured based on ISO 1133 in accordance with ISO 14663), flexural elasticity of 3.9 GPa (as measured in accordance with ISO 178 based on ISO 1466), and a contact angle of 64° (as measured by the sessile water drop method at 23° C. and 50% RH by using a contact angle meter “FAMAS”, product of Kyowa Interface Science) completely molten at 250° C. in a heating furnace was injected under pressure of from 4 to 6 atmospheres from an inlet disposed in advance by spruing. After cooling at room temperature for 30 minutes, the resulting solid was taken out from the investment mold and its fitness was confirmed using the diagnostic model. Finally, the base and fitting member portions thereof were polished, whereby the dental prosthetic appliance as shown in FIG. 1 was obtained.

During fabrication, the molten resin was filled completely in the cavity of the mold at the time of injection molding so that the prosthetic appliance uniform without air bubbles mixed therein was formed. The outer surface of it taken out from the mold had good smoothness. On the other hand, the inner surface had irregularities as a result of faithful reproduction of the surface of the plaster cast, but was flattened uniformly by sandblasting.

### Example 2

A saponified ethylene-vinyl acetate copolymer (having an ethylene content of 38 mole %, an average saponification degree of 99.6 mole %, MFR of 3.3 g/10 min (as measured based on ISO 1133 in accordance with ISO 14663), flexural elasticity of 3.2 GPa (as measured in accordance with ISO 178 based on ISO 1466), and a contact angle of 74° (as measured by the sessile water drop method at 23° C. and 50% RH by using a contact angle meter “FAMAS”, product of Kyowa Interface Science) was injection molded into a sheet having a thickness of 1 mm. The sheet was cut into a 6×20×1 mm chip.

The chip was inserted between the mucosa in the upper lip and gingival for 3 hours and feeling caused by it as an intraoral material was confirmed. It blended well in the saliva, did not cause any discomfort and provided an adsorption feeling to the gingival surface. In addition, it did not adversely affect the conversation.

### Example 3

In a similar manner to Example 2 except for the use of a saponified ethylene-vinyl acetate copolymer having 1.5 mole % of a structural unit represented by the formula (1) (wherein, R¹ to R⁶ each represents a hydrogen atom and X represents a single bond), an ethylene content of 37 mole %, an average saponification degree of 99.6 mole %, an MFR of 4.0 g/10 min), and a contact angle of 72° (as measured by the sessile water drop method at 23° C. and 50% RH by using a contact angle meter “FAMAS”, product of Kyowa Interface Science), a chip was prepared. The flexural elasticity of saponified ethylene-vinyl acetate copolymer is calculated to be 3.2 GPa (as estimate value measured in accordance with ISO 178 based on ISO 1466). As a result of evaluation of the chip as in Example 2, it provided a good insertion feeling.

### Comparative Example 1

In a similar manner to Example 2 except for the use of a high density polyethylene having a contact angle of 104° (as measured by the sessile water drop method at 23° C. and 50% RH by using a contact angle meter “FAMAS”, product of Kyowa Interface Science) instead of the saponified ethylene-vinyl acetate copolymer, a chip was prepared. As a result of evaluation of the chip as in Example 2, it provided a discomfort from the beginning of the insertion and no improvement was observed even after the passage of time.

### Comparative Example 2

In a similar manner to Example 2 except for the use of polyethylene terephthalate instead of the saponified ethylene-vinyl acetate copolymer, a chip was prepared. As a result of evaluation of the chip as in Example 2, it provided a discomfort from the beginning of the insertion and no improvement was observed even after the passage of time.

### Comparative Example 3

In a similar manner to Example 2 except for the use of polycarbonate instead of the saponified ethylene-vinyl acetate copolymer, a chip was prepared. As a result of evaluation of the chip as in Example 2, it provided a discomfort from the beginning of the insertion and no improvement was observed even after the passage of time.

### Comparative Example 4

In a similar manner to Example 2 except for the use of polyamide instead of the saponified ethylene-vinyl acetate copolymer, a chip was prepared. As a result of evaluation of the chip as in Example 2, it provided a discomfort from the beginning of the insertion and no improvement was observed even after the passage of time.

The dental prosthetic appliance of the invention using EVOH is useful, because it has adequate strength, has a high level of safety, has excellent adhesion to the oral mucosa owing to excellent hydrophilicity, and can be obtained easily by molding or forming. Generally known EVOH resins have hydrophilicity and moldability or formability so that it is obvious that the use of the EVOH resin for dental prosthetic appliances brings about the above-described advantages of the invention.

This application is based on Japanese patent application JP 2006-226662, filed on Aug. 23, 2006, the entire content of which is hereby incorporated by reference, the same as if set forth at length.

What is clamed is:

1. A dental prosthetic appliance comprising a plastic material, wherein the plastic material is a saponified ethylene-vinyl ester copolymer.

2. The dental prosthetic appliance according to claim 1, wherein the saponified ethylene-vinyl ester copolymer is a saponified ethylene-vinyl acetate copolymer.

3. The dental prosthetic appliance according to claim 1, wherein the saponified ethylene-vinyl ester copolymer has an ethylene structural unit content of 1 to 70 mole %.

4. The dental prosthetic appliance according to claim 1, wherein the saponified ethylene-vinyl ester copolymer has an ethylene structural unit content of 10 to 60 mole %.

5. The dental prosthetic appliance according to claim 1, wherein the saponified ethylene-vinyl ester copolymer has an ethylene structural unit content of 20 to 55 mole %.

6. The dental prosthetic appliance according to claim 1, wherein the saponified ethylene-vinyl ester copolymer has an ethylene structural unit content of 25 to 50 mole %.

7. The dental prosthetic appliance according to claim 1, wherein the saponified ethylene-vinyl ester copolymer has an average saponification degree of 80 to 100 mole %.

8. The dental prosthetic appliance according to claim 1, wherein the saponified ethylene-vinyl ester copolymer has an average saponification degree of 90 to 100 mole %.

9. The dental prosthetic appliance according to claim 1, wherein the saponified ethylene-vinyl ester copolymer has an average saponification degree of 95 to 100 mole %.

10. The dental prosthetic appliance according to claim 1, wherein the saponified ethylene-vinyl ester copolymer has an average saponification degree of 99 to 100 mole %.

11. The dental prosthetic appliance according to claim 1, wherein the saponified ethylene-vinyl ester copolymer has a remaining amount of sodium acetate of 1,000 ppm or less, in terms of sodium.

12. The dental prosthetic appliance according to claim 1, wherein the saponified ethylene-vinyl ester copolymer has a remaining amount of sodium acetate of 500 ppm or less, in terms of sodium.

13. The dental prosthetic appliance according to claim 1, wherein the saponified ethylene-vinyl ester copolymer has a remaining amount of sodium acetate of 300 ppm or less, in terms of sodium.

14. The dental prosthetic appliance according to claim 1, wherein the saponified ethylene-vinyl ester copolymer has a melt flow rate at 210° C. under a load of 2,160 g of 0.5 to 100 g/10 minutes.

15. The dental prosthetic appliance according to claim 1, wherein the saponified ethylene-vinyl ester copolymer has a melt flow rate at 210° C. under a load of 2,160 g of 1 to 50 g/10 minutes.

16. The dental prosthetic appliance according to claim 1, wherein the saponified ethylene-vinyl ester copolymer has a melt flow rate at 210° C. under a load of 2,160 g of 3 to 40 g/10 minutes.

17. The dental prosthetic appliance according to claim 1, wherein the saponified ethylene-vinyl ester copolymer has a contact angle with water of 5° to 85°.

18. The dental prosthetic appliance according to claim 1, wherein the saponified ethylene-vinyl ester copolymer has a contact angle with water of 30° to 80°.

19. The dental prosthetic appliance according to claim 1, wherein the saponified ethylene-vinyl ester copolymer has a flexural elasticity from 1 to 9.9 Gpa.

20. The dental prosthetic appliance according to claim 1, which contains a filler in an amount of from 0.5 to 45 parts by weight.

21. The dental-prosthetic appliance according to claim 1, wherein the saponified-ethylene-vinyl ester copolymer further contains a 1,2-diol structural unit represented by the following formula (1): 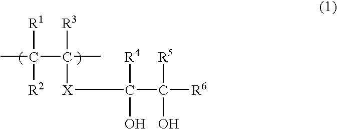
wherein R¹, R² and R³ each independently represents a hydrogen atom or an organic group, X represents a single bond or linking chain, and R⁴, R⁵ and R⁶ each independently represents a hydrogen atom or an organic group.

22. The dental prosthetic appliance according to claim 1, wherein the saponified ethylene-vinyl ester copolymer further contains a 1,2-diol structural unit represented by the following formula (1) from 0.1 to 20 mole %: 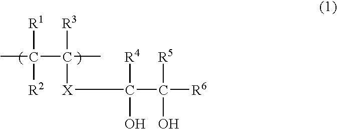
wherein R¹, R² and R³ each independently represents a hydrogen atom or an organic group, X represents a single bond or linking chain, and R⁴, R⁵ and R⁶ each independently represents a hydrogen atom or an organic group.

23. The dental prosthetic appliance according to claim 1, wherein the saponified ethylene-vinyl ester copolymer is a saponified ethylene-vinyl acetate copolymer, which has an ethylene structural unit content of 10 to 60 mole %, has an average saponification degree of 80 to 100 mole %, has a melt flow rate at 210° C. under a load of 2,160 g of 0.5 to 100 g/10 minutes, and has a contact angle with water of 5° to 85°, and has a flexural modulus of 1 GPa to 9.9 GPa.

24. The dental prosthetic appliance according to claim 1, wherein the saponified ethylene-vinyl ester copolymer is a saponified ethylene-vinyl acetate copolymer, which has an ethylene structural unit content of 10 to 60 mole %, has an average saponification degree of 80 to 100 mole %, has a melt flow rate at 210° C. under a load of 2,160 g of 0.5 to 100 g/10 minutes, has a contact angle with water of 5° to 85°, has a remaining amount of sodium acetate of 1,000 ppm or less, in terms of sodium, and has a flexural modulus of 1 GPa to 9.9 GPa.

25. The dental prosthetic appliance according to claim 1, which is a denture base.

26. The dental prosthetic appliance according to claim 1, which is a denture fitting member.

27. The dental prosthetic appliance according to claim 26, wherein the denture fitting member has a flexural modulus of 2 GPa to 9.9 GPa.
